(19) United States
(12) Patent Application Publication
(10) Pub. No.: US 2026/0297392 A1
(43) Pub. Date: Oct. 1, 2026

(54) PATTERNED ADHESIVES FOR USE WITH TRANSFER PRINTING

(71) Applicant: Avery Dennison Corporation, Mentor, OH (US)

(72) Inventors: Radha SEN, Mentor, OH (US); Liviu DINESCU, Huntersville, NC (US); Jason RAMBLER, Decatur, GA (US)

(21) Appl. No.: 19/476,752

(22) PCT Filed: May 9, 2024
(86) PCT No.: PCT/IB2024/054524

§ 371 Date: Oct. 20, 2025

Related U.S. Application Data
(60) Provisional application No. 63/501,494, filed on May 11, 2023.

(51) Int. Cl. C09J 7/38

(52) U.S. Cl. CPC C09J 7/38; C09J 2301/204; C09J 2301/208; C09J 2301/302; C09J 2301/416

(57) ABSTRACT

According to an exemplary embodiment, this disclosure is directed to patterning of adhesives in a transfer print environment. The method generally includes depositing a first curable adhesive in a pattern thereby creating voids, curing the first curable adhesive, depositing a second curable adhesive in the voids of the first curable adhesive and curing the second curable adhesive. Beneficial properties may result through the use of patterning of adhesives and using multiple adhesives.

### TECHNICAL FIELD

This disclosure generally relates to depositing a first curable adhesive in a pattern thereby creating voids, curing the first curable adhesive, depositing a second curable adhesive in the voids of the first curable adhesive and curing the second curable adhesive. More specifically, the disclosure relates to using an ink-jet printer to deposit a first curable adhesive with a viscosity greater than that of a second curable adhesive later deposited.

### BACKGROUND

In addition to home and office usage, inkjet technology has been expanded to high-speed, commercial and industrial printing. Inkjet printing is a non-impact printing method that utilizes electronic signals to control and direct droplets or a stream of ink to be deposited on media. Current inkjet printing technology involves forcing the ink drops through small nozzles by thermal ejection, piezoelectric pressure or oscillation onto the surface of the media. This technology has become a popular way of recording images on various media surfaces (e.g., paper), for a number of reasons, including, low printer noise, capability of high-speed recording and multi-color recording.

In addition to ink applied in this manner, so too can adhesives. Because of the low viscosity requirements of ink jet printing processes, prior art adhesives jetted from inkjet nozzles do not typically have sufficiently high viscosity and tackiness when they reach and are deposited on the substrate. High viscosity and high surface tackiness properties, however, are essential for proper transfer. Prior art approaches have applied UV curing dosages short of that needed to fully cure and harden a singular adhesive in order to manipulate adhesive viscosity and initiate the onset of adhesive tackiness. This substantially increases the complexity of the process and its expense. It also leads to subpar image formation due to lack of hardness in the adhesive layer.

### SUMMARY

Exemplary embodiments relate to a method comprising: depositing a first adhesive in a pattern, wherein the pattern has a length, a width, and a depth and locations with no depth of a first adhesive thereby creating a resultant void; curing the first adhesive; depositing a second adhesive within the resultant void of the pattern; and curing the second adhesive. This embodiment or another exemplary embodiment may provide for the first adhesive to be a pressure sensitive adhesive. This embodiment or another exemplary embodiment may provide for the second adhesive to be a structural adhesive. This embodiment or another exemplary embodiment may provide the height is a first height of the first adhesive and the second adhesive has a second height and wherein the first height is greater than or equal to the second height. This embodiment or another exemplary embodiment may provide the curing of the first adhesive occurs through actinic radiation. This embodiment or another exemplary embodiment may provide the curing of the second adhesive occurs through actinic radiation. This embodiment or another exemplary embodiment may provide a viscosity of the first adhesive is greater than a viscosity of the second adhesive. This embodiment or another exemplary embodiment may provide the depositing the first adhesive occurs through an ink-jet printer. This embodiment or another exemplary embodiment may provide the depositing the second adhesive occurs through an ink-jet printer. This embodiment or another exemplary embodiment may provide the resultant void is shaped like a polygon in cross section along the width and length.

Another exemplary embodiment relates to a first cured adhesive applied in a pattern to a substrate, wherein the pattern includes a plurality of voids; and a second cured adhesive applied within the plurality of voids of the first adhesive. This embodiment or another exemplary embodiment may provide the first cured adhesive was a UV-curable adhesive prior to being cured. This embodiment or another exemplary embodiment may provide the first cured adhesive is a pressure sensitive adhesive. This embodiment or another exemplary embodiment may provide the second cured adhesive was a UV-curable adhesive prior to being cured. This embodiment or another exemplary embodiment may provide the second cured adhesive is a structural adhesive. This embodiment or another exemplary embodiment may provide the first cured adhesive has a first height and the second cured adhesive has a second height and wherein the first height is greater than or equal to the second height. This embodiment or another exemplary embodiment may provide the first cured adhesive prior to curing has a viscosity greater than the second cured adhesive prior to curing. This embodiment or another exemplary embodiment may provide the pattern of the first cured adhesive is grid shaped. This embodiment or another exemplary embodiment may provide the pattern of the second cured adhesive is polygon shaped when viewed in cross section along the width and length. This embodiment or another exemplary embodiment may provide the pattern of the second cured adhesive is rectangle shaped when viewed in cross section along the width and length.

### BRIEF DESCRIPTION OF THE DRAWINGS

FIG. 1 depicts a schematic prior art set up of a standard transfer print mechanism.

FIG. 2 depicts a flow chart of the prior art set up of a standard transfer print mechanism.

FIG. 3 depicts a schematic set up of an exemplary embodiment of a transfer print mechanism.

FIG. 4 depicts a flow chart of the exemplary embodiment of a transfer print mechanism.

FIG. 5 depicts an exemplary patterned adhesive in accordance with at least one exemplary embodiment.

FIG. 6 depicts an additional exemplary patterned adhesive in accordance with at least one exemplary embodiment.

FIG. 7 depicts a schematic set up of an alternative exemplary embodiment of a transfer print mechanism.

FIG. 8 depicts a schematic set up of an yet another alternative exemplary embodiment of a transfer print mechanism.

### DEFINITIONS

As used herein, “pattern” refers to a three-dimensional deposition on a surface with a length, width and depth.

As used herein “void” refers to a three-dimensional space on a surface uncovered by the pattern. The spaces created by the length, width, and depth of the pattern define a resultant void within the pattern.

As used herein, “regular pattern” means the evenness, consistency, and/or balance in shape, including consistent length, widths, and depths; arrangement, and/or pattern orientation variation and homogeneity that is repeating.

As used herein, “irregular pattern” means a pattern that is not even or balanced in shape, including consistent length, widths, and depths; arrangement, and/or pattern orientation variation and heterogeneity that is non-repeating.

As used herein, “repeat pattern” means the pattern of adhesive is regular in terms of shape including consistent length, widths, and depths; arrangement and/or pattern orientation and heterogeneity is repeating.

As used herein, “gsm” means grams per square meter.

### DETAILED DESCRIPTION

### Adhesives

The embodiments described herein contain two or more UV-curable or actinic curable adhesives. The adhesive(s) can be a PSA, a non-pressure sensitive adhesive, a hot-melt adhesive, or combinations thereof. In some embodiments, the first adhesive is a PSA. The PSA may be any known PSA. In some embodiments, the PSA is a solvent type adhesive, an emulsion type adhesive, or non-emulsion type adhesive. In some embodiments, the PSA is an emulsion adhesive. Hot melt PSAs may also be used. The adhesive may be acrylic or any other useful adhesive which has the hardness and adhesive properties needed for the laminates and/or adhesive coated facestocks. In certain embodiments, the adhesive should have a hardness sufficient to prevent the adhesive squeezing out of the laminate or article during processing.

Exemplary PSAs may be found in (1) Encyclopedia of Polymer Science and Engineering, Vol. 13, Wiley-Interscience Publishers (New York, 1988); (2) Polymer Science and Technology, Vol. 1, Interscience Publishers (New York, 1964); (3) those described in U.S. Pat. Nos. 5,164,444; 5,183,459; and 5,264,532, all issued to Bernard, and U.S. Pat. No. 5,385,965, issued to Bernard et al; and (4) combinations thereof. The PSAs may be a solvent based or may be a water based adhesive. Conventional PSAs, including acrylic-based PSAs, rubber-based PSAs and silicone-based PSAs may be used in the laminates/constructs described herein. In one embodiment, the pressure sensitive adhesive contains an acrylic emulsion adhesive.

In some embodiments, the pressure sensitive adhesive is prepared by polymerizing alkyl acrylates, vinyl esters, diesters of dicarboxylic acids and unsaturated acids. The alkyl acrylates typically contain from about 2 to about 12, or from about 4 to about 8 carbon atoms in the alkyl group. Examples of alkyl acrylates include, but are not limited to, ethyl, n-butyl, hexyl, 2-ethylhexyl, and isooctyl acrylates, with 2-ethylhexyl acrylate preferred. In one embodiment, the alkyl acrylates are present in an amount of at least about 35%. In some embodiments, the alkyl acrylates are present in an amount from about 35% to about 60% by weight.

The vinyl esters typically have from about 2 to about 12, or from about 4 to about 8 carbon atoms in the alkyl group. Examples of vinyl esters include, but are not limited to, vinyl acetate, vinyl propionate, vinyl butyrate, vinyl versatate and the like, with vinyl acetate being preferred. In some embodiments, the vinyl esters are present in an amount from about 15% to about 35% or from about 20% to about 25% by weight.

The diesters of the dicarboxylic acids include alkyl esters of unsaturated diacids, such as maleic acid or anhydride and fumaric acids. The alkyl group generally contains from about 2 to about 20, or from about 4 to about 16, or from about 6 to about 12 carbon atoms. Examples of diesters of diacids include, but are not limited to, butyl, octyl fumarate; hexyl, decyl maleate; di-2-ethylhexyl maleate; di-butyl fumarate; and di-2-ethylhexyl fumarate and mixtures thereof. In some embodiments, the diesters of diacids are present in an amount from about 20% to about 35% by weight.

The unsaturated acids generally contain from about 2 to about 12, or from about 2 to about 6 carbon atoms. Examples of the unsaturated acids include, but are not limited to, acrylic acid, methacrylic acid, itaconic acid, and the like. In some embodiments, the unsaturated acids are present in an amount up to 5% or from about 1% to about 3% by weight.

In the exemplary embodiment, the second adhesive is a structural adhesive. A structural adhesive, refers to an adhesive that forms an interfacial bond having greater bond strength (adhesive strength) than the cohesive strength of either the substrate or the adhesive itself, or both. In one embodiment, the structural adhesive forms chemical bonds with, for example, polar groups located on a substrate surface. As such, the adhesive bond may be tenacious and can be selected to be resistant to aggressive agents or environments, such as solvents or acids in the case of agents, and temperature extremes in the case of environment. Other structural adhesives may be employed, alone or in combination with the noted structural adhesives, that can strongly, but not permanently bond to a substrate surface. The bond strength can be determined by, for example, the selection of materials. In one embodiment, the structural adhesive may be a permanent and difficult to remove adhesive that is chemically bonded to a substrate surface. Upon removal of the adhesive, the underlying substrate can potentially be destroyed.

In exemplary embodiments, the coat weight of adhesives may be between 2 and 100 gsm.

### Release Liners

In some embodiments, the laminates described herein may include one or more release liner(s). The liner may have a first side, a second side opposed to the first side, a first edge, and a second edge opposed to the second edge. The liner may be any useful liner which provides necessary support and release properties. The liner may be made of, or from, a variety of materials including, but not limited to, paper or polymer film liners. In one embodiment, the caliper of the paper is sufficient to die cut the resulting laminate or article. For example, liner calipers can range from about 18 mm to 23 mm for PET liners. In one embodiment, the liner has lay flat properties. In some embodiments, the liner has a machine glaze or finish. In some embodiments, the liner has a silicone hold out layer. The hold out layer provides adhesion between the release coating and the release liner. The silicone holdout layer also prevents the silicone release coating from soaking into the liner.

In some embodiments, the release liner includes a liner having a release coating. The release coating of the release liner provides a releasable bond with the PSA or other adhesive. The release coating may be any composition which provides a desired releasable bond strength.

In one embodiment, the release coating is a silicone release coating. The release coating can be prepared by curing silicone polymers in the presence of a control release agent. In some embodiments, the control release agent is a copolymer of a monofunctional silicone unit of the formula R₃SiO_{1/2} and tetrafunctional silicone units SiO_{4/2} wherein R is an alkyl or alkenyl group. In one embodiment, the alkyl or alkenyl groups contain from about 1 to about 12, or from about 1 to about 6 carbon atoms. Non-limiting examples of alkyl and alkenyl groups include methyl, ethyl, propyl, butyl, hexyl, ethenyl, propenyl, butenyl and hexenyl groups.

The control release agent is typically reacted with a polysiloxane. The polysiloxane may be any polysiloxane which is useful in forming a release coating. Examples of useful polysiloxanes include, but are not limited to, vinyl terminated, hydroxy terminated and epoxy terminated polysiloxanes. In one embodiment, the polysiloxane is a functional polydialkyl siloxane, wherein the alkyl group contains from about 1 to about 6 carbon atoms. The alkyl groups independently include, but are not limited to, methyl, ethyl, propyl, butyl, pentyl, hexyl groups or mixtures thereof. In one embodiment, the alkyl or alkenyl group contains from 1 to about 12, or from 1 to about 6 carbon atoms. The polysiloxane typically has a viscosity average molecular weight of greater than 300,000 centipoise (cps). In another embodiment, the polysiloxane has a viscosity molecular weight from about 300,000 to about 1,000,000 or more. The polysiloxane may be represented by the formula (I):

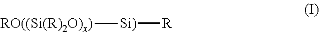

wherein each R is independently as defined above and x is an integer.

In some embodiments, the release coating is prepared with a cross linking agent. In some embodiments, the cross linking agent is a reactive polysiloxane, such as a polydialkyl or polyhydroalkyl siloxane. The alkyl groups are the same as those described above.

The release coating may be applied in a solvent, solvent-less or emulsion form. The release coating may be cured by any known curing process, e.g. thermal, radiation, etc., to form the release coating. The curing may be catalyzed by silicone soluble complexed compounds of Group VIII transition metals, such as platinum.

Commercially available release agents include, but are not limited to, GE SS-4335, a silicone release agent in unreactive solvent. Commercially available polysiloxanes include, but are not limited to, GE SS-4331, a vinyl terminated polydimethyl siloxane. Commercially available linking agents include, but are not limited to, GE SS-4300C, a polymethyvinyl siloxane. Exemplary catalysts include, but are not limited to, SS-8010 catalyst in toluene. These materials are available commercially from General Electric Company's Silicone Products Division. Similar silicone products are available under the tradename Syl-off from Dow Corning Corporation.

It will be understood that the present subject matter is not limited to any of the noted release coatings or agents, and instead includes nearly any release coating or agent suitable for the intended end use application. Furthermore, although the present subject matter has been described in association with release liners, it will be appreciated that appropriately configured carrier films and other members could be used instead of release liners.

### Face Material

Suitable face materials include, but are not limited to, synthetic papers such as polyolefin type and polystyrene type; various plastic films or sheets such as polyolefin, polyvinyl chloride, polyethylene terephthalate, polystyrene, polyurethane, polymethacrylate and polycarbonate. Additional examples of suitable face materials include paper and cardboard. The face material may be, or may include, a multilayer polymeric sheet. The multi-layers may be coextruded, or the multi-layers may be laminated together. In one embodiment, the face material includes both co-extruded multi-layers and laminated multi-layers. In addition, a white opaque film may be formed by adding a white pigment to one or more of the aforementioned synthetic resins and used as the face material. In one embodiment, a foamed film is used as the face material. The foamed film may be formed by a conventional foaming operation. In another embodiment, the face material may be a laminated body formed by combining a plurality of single layered sheets composed of the above listed materials. Examples of such a laminated body may include the combination of cellulose fiber paper with synthetic paper, and a laminated body of combined cellulose fiber paper with a plastic film or sheet. In another suitable embodiment, the face material includes coated and uncoated papers, metalized papers, aluminum foil, laminated paper and paper with a polymeric material extruded onto the surface of the paper. In certain versions, the face material can be coated with a liquid absorbent material. The selected face material may be porous or semi-porous. The face material may exhibit certain visibility characteristics such as opaqueness, color, and/or brightness. The face material may include water or other liquid absorbency properties. The face material may be electrically conductive and/or include electrically conductive coatings or regions. A wide array of commercially available face materials can be used such as for example those available under the designation TESLIN.

The thickness of the face material is optionally determined with reference to application specific criteria. Such criteria may include the desired end use. In one embodiment, the sheet thickness is in a range of from about 10 μm to about 300 μm. In another embodiment, the sheet thickness is in a range of from about 20 μm to about 200 μm. In still another embodiment, the sheet thickness is in a range of from about 30 μm to about 150 μm. Optionally, a primer treatment or a corona discharging treatment or a plasma treatment may be used on the face material to increase a bonding strength between the face material and a dried topcoat composition to be formed on a surface of the face material.

In certain embodiments described herein, the face material exhibits one or more functions or functional characteristics. For example, the face material may be selected to enable or promote an indication such as a visual indication of a liquid, outgassing such as directing or allowing flow of air or gas across a thickness of the face material, water or liquid retention within the face material, electrical discharge or conductivity of the face material, chemical delivery across a thickness of the face material, passage of sound across a thickness of the face material, and/or combinations of these functions or characteristics.

### Optional Layers

The adhesive coated face material and/or laminates described herein can include one or more additional layers or components. Non-limiting examples of such layers include protective layers, tie coat layers, clear layers, color layers, white layers, reflective layers, fluid transfer layers, strength promoting layers, topcoats, print receptive layers, print containing layers, indicia layers, functional layers, and the like.

### Laminate Properties

The laminates described herein may have specific and useful properties or functionalities. In some embodiments, the techniques described herein enable formation of laminates in which transfer, propagation, and/or migration of liquid, gas, sound waves, electrical current, and/or other agents or elements can occur and is controlled across or through the laminate in a Z-direction. The reference to “Z-direction” as made herein refers to a direction across a thickness dimension of a laminate or portion thereof, and thus references to “X-direction” and/or “Y-direction” refer to directions perpendicular to the Z-direction and correspond to width and length dimensions of the laminate.

Non-limiting representative examples of laminates having certain functionalities which are provided by the present subject matter include liquid indicator laminates, outgassing laminates, water absorbent laminates, sound channeling laminates, electrically conductive laminates, and laminates having combinations of these functionalities and/or laminates having combinations of one or more of these functionalities and additional functionalities.

For example, a liquid indicator laminate can be produced such that the speed of the indicator color change is linked to the facestock selection and porous adhesive properties. A discontinuous structure, such as resulting from pores in the adhesive layer or region(s), can allow, for example, liquid to channel through the discontinuous adhesive from one side of the adhesive to the other side and create a permanent discoloration when a dye or other agent in a functional coating in the laminate is dissolved.

In one embodiment, a liquid indicator laminate is provided. The speed or rate of the indicator color change is linked to the facestock properties such as for example absorbency of liquid, and porosity of the pattern adhesive in the Z-direction. The indication typically is irreversible and can be measured by color change or by a simple visual comparison.

The discoloration of a face or region of the laminate can be measured and quantified by optical change, such as by CIE Lab or by a simple visual comparison. The discoloration can be permanent or nonpermanent. The discoloration can also be temporary and revert to an initial state after passage of a period of time. In some embodiments, the period of time is predetermined.

This phenomenon of transport through discontinuities in an adhesive in the Z-direction can be implemented in other label applications and particularly pressure sensitive adhesive labels, such as for example, labels for outgassing substrates such as by air channeling in the Z-direction, moist substrate labeling such as by liquid channeling in the Z-direction, electrical discharge in the Z-direction, chemical delivery from one layer to another in the Z-direction, and/or sound channeling in the Z-direction. This phenomenon enables passage, transfer, and/or migration of a medium or agent from one side of an adhesive region of a laminate, to another side of the adhesive region. Although medium penetration or transport is noted as being in the Z-direction, it will be understood that the present subject matter is not limited to such and may also include penetration/transport in the X-direction and/or Y-direction.

In some embodiments, the laminates described herein include a layer or region of a secondary adhesive. The secondary adhesive is typically utilized to adhere the laminate to a substrate of interest. The secondary adhesive may contain one or more adhesives which are the same or different than the adhesive of the patterned or porous adhesive. Description of representative examples of secondary adhesives are provided herein. In such an adhesive configuration, the primary adhesive may be coated onto the facestock, the secondary adhesive may be coated onto the release liner, and the coated adhesive and release liner may be laminated together such that the primary and secondary adhesives are in direct contact with each other. Alternatively, or additionally, both the primary and secondary adhesive may be coated on the facestock or the release liner, then laminated together. It is contemplated that the layering of the primary and secondary adhesive relative to the facestock and the release liner may be either facestock, primary adhesive, secondary adhesive, and release liner or facestock, secondary adhesive, primary adhesive, release liner. Regardless of the order of primary and secondary adhesive, it is contemplated that at least one of the primary and secondary adhesive is patterned, taking into consideration that the other adhesive may be continuous.

In some embodiments, an array of different arrangements of layers and components may be utilized. In some embodiments using the patterned adhesive, e.g., the layer of discontinuous adhesive, that layer is disposed between a functional facestock and a liner or functional layer. And in the liquid indicator laminates, the patterned adhesive may be disposed between the functional facestock and the layer or region of functional agent that is sensitive to liquid passing through the laminate. And, in the liquid indicator laminates, the layer or region of the functional agent may be disposed between the patterned adhesive and the carrier layer.

Utilization of the techniques and features described herein enable production of adhesive laminates and/or adhesive coated face materials with fluid/air management characteristics, controlled removability, and/or unique thermal and/or electrical conductivity. In addition, use of these techniques and features enable reductions in materials, e.g., adhesives, and thus enable cost savings. However, it will be understood that the present subject matter includes the adhesive coated face materials and laminates described herein which are formed by other methods than the methods described herein.

### Top Coat Formulation and Application

In exemplary embodiments discussed herein, the top coat coating is deposited on the substrate by any suitable method. In embodiments, the suitable method includes any suitable coating technology. Embodiments include depositing the coating on the substrate by any suitable liquid deposition method. Without limitation, examples of suitable methods include bath coating, spray coating, slot coating, spin coating, curtain coating, gravure coating, reverse gravure print coating, reverse roll coating, knife over roll (i.e., gap) coating, metering (Meyer) rod coating, air knife coating, or any combinations thereof. Bath coating includes immersion or dip in the aqueous solution. In an embodiment, the coating is deposited by bath in the aqueous solution. In other embodiments, the coating is deposited by spray of the aqueous solution.

### Methods

Having discussed various components of the composition, exemplary methods and methodologies of operation of use of the compositions will be discussed.

### Transfer Print

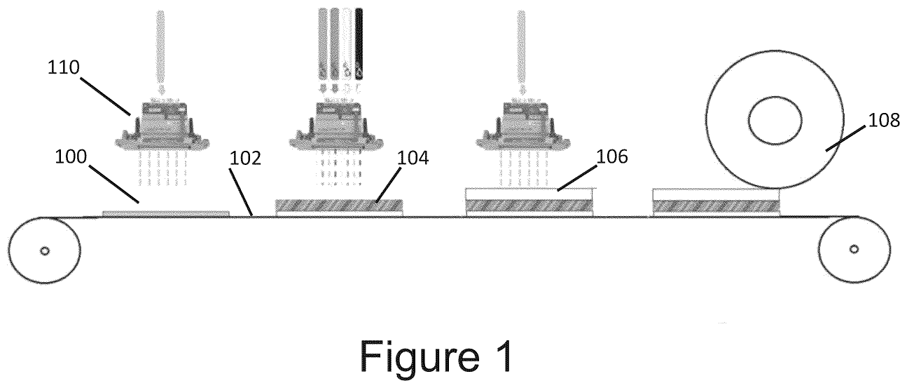

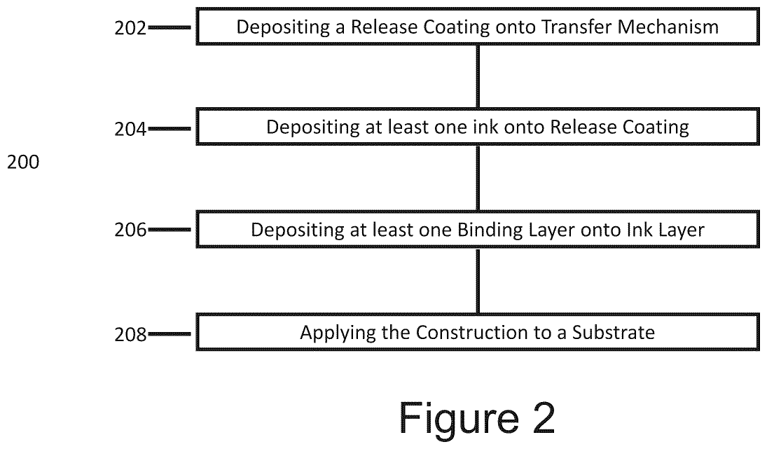

The adhesives discussed herein can be applied via a transfer printing process. FIGS. 1 and 2 illustrate a general example, of such a process (200). The general example utilizes a transfer mechanism that the components of the label are first applied to and then is used to transfer those components onto the desired substrate. As shown in FIGS. 1 and 2, a release coat 100 is deposited onto the transfer mechanism 102 (Step 202) with an ink layer 104 and then a binding layer 106 is deposited (Step 204) on top of ink layer 104. Ink layer 104 and/or binding layer 106 are then dried and/or cured (Step 206) while attached to transfer mechanism 102, and ink layer 104 and binding layer 106 are then applied (Step 208) to a substrate 108 as the adhesive of binding layer 106 contacts substrate 108 on a roller or other similarly situated mechanism.

As indicated above, transfer mechanism 102 is utilized to house the components of the label (i.e., the ink layer 104 and binding layer 106 and possible other components, as discussed further below) prior to the components' application to the particular substrate. Advantageously, the transfer mechanism may be utilized again and again thereby reducing the amount of waste typically associated with such methods.

The transfer mechanism 102 used comprises a moving conveyer belt or sheet feed. To meet the requirements of such methods, transfer mechanism 102 may be a diaphragm constructed on a moving conveyer belt or in a sheet feed system to aid in the process of the application of the necessary label components onto the substrate and then to repeat to process. The conveyer belt may be continuously moving or may utilize a batch-movement process, or a semi-batch movement process, depending on the specifications of the user.

Transfer mechanism 102 may be constructed of any material or materials that allow for the various label components to be transferred on and off transfer mechanism 102 and allow for transfer mechanism 102 to maintain its shape during the application of the label components but further allow flexibility to conform to the shape of the substrate. For example, if a diaphragm is used for the construction of transfer mechanism 102, it may include a textured or matte surface to increase the ease of releasability of the label components to the substrate. In addition, where a diaphragm is utilized, suitable materials for the construction of the belt that provide enhanced release qualities as well as the desired flexibility may include silicone, fluorinated polymers, or low surface energy polymers including polyamide, Teflon®, polyolefin, and others. Such materials may be utilized to construct the entirety of the diaphragm or may serve as coatings (such as those shown as 100) on the diaphragm depending on the user's specifications. Examples of suitable silicone coated release materials include, D2 CL PET 7300A/7350A, Grade 27320 and 2SLKN and 5.0 MT PET 4400/4400 Grade 26967 from Loparex LLC in lowa City, IA. In addition, suitable polymer examples include, acrylic-based coatings, such as R130W from Mayzo, Inc. in Suwanee, GA and polypropylene based coatings, such as HFM sheets from Avery Dennison NTP in Pasadena, CA.

To ensure the proper releasablity of the label components from transfer mechanism 102, the surface energy of transfer mechanism 102 on the side that makes contact with the label components may be between about 20 mN/m and about 40 mN/m. In some examples, including those where silicone is utilized in the construction of transfer mechanism 102, additional items, including corona treatment or flame treatment, may be added to transfer mechanism 102 to ensure the proper surface energy.

Ink layer 104 utilized in the methods may include ink or graphics, and may be a mono-colored or multi-colored ink layer depending on the printed message and/or the intended pictorial design. Such designs for use in connection with the present methods include serial numbers, bar codes, trademarks, etc.

The present methods may utilize a variety of commercially available inks for use in ink layer 104 including UV-curable, latex, water-based, nonpolar, solvent-based, pigments, dyes, solvent-based with polar functionality, Eco-solvent, hot-solvent, solventless, 100% solid and others. Examples of these inks include Sun Sheen® (a product of Sun Chemical, Inc. of Santa Fe Springs, CA identified as an alcohol dilutable polyamide ink), Suntex MP (a product of Sun Chemical, Inc. identified as a solvent-based ink formulated for surface printing acrylic coated substrates, PVDC coated substrates and polyolefin films), X-Cel (a product of Water Ink Technologies, Inc. of Lincolnton, NC identified as a water-based film ink for printing film substrates), Uvilith AR-109 Rubine Red (a product of Daw Ink, Inc. of Commerce, CA identified as a UV ink) and CLA91598F (a product of Sun Chemical, Inc. identified as a multibond black solvent-based ink). Ink layer 104 may range from about 0.5 to about 10 μm. Further, the thickness of ink layer 104 may range from about 1 to about 5 μm, and, furthermore, the thickness of ink layer 104 may be about 3 μm.

The application of release coating 100, ink layer 104 or binding layer 106 to transfer mechanism 102 or other such layers may be accomplished by various methods known and apparatuses 110 as known in the art, including inkjet printing, screen printing, or coating. The ink layer may be deposited through raster graphics or bitmap imaging, which is sometimes referred to in the printing and prepress industries as contone or contone printing. Where inkjet printing is used, a thermal inkjet printer or piezo inkjet printer may be utilized to apply ink layer 104 to transfer mechanism 102. In such a case, the ink of ink layer 104 utilized in the method should be of a suitable viscosity when passing through the printhead of such printers to ensure an accurate and durable image. For example, thermal inks may include a viscosity of between about 3 and about 5 mPa/s at 25° C., while piezo ink jet fluids may include a viscosity in the range of about 1 to about 30 mPa/s at 25° C.

Binding layer 106 may be constructed of inkjettable adhesives to meet the demands of the method utilized. For example, binding layer 106 may be constructed of monomers, including those of acrylic, epoxy, silicone, vinyl, and olefinic based chemistries. Oligomers or short chain polymers may be utilized in connection with binding layer 106. Short chain polymers that may be beneficial in connection with binding layer 106 refers to polymers where number average molecular weight (Mn) is less than the entanglement molecular weight (Me) for the respective monomeric systems. In addition, to allow such materials to consistently jet through an inkjet nozzle, the materials utilized as binding layer 106 may include a viscosity range between about 5 to about 50 mPa·s.

Where inkjettable adhesives are utilized in connection with binding layer 106, such adhesives may be prepared using any known methods in the art including, emulsion, solvent or solvent-less polymerization techniques, where such inkjettable adhesives may be processed using a solvent, water or a heated nozzle. The user's specifications may dictate the necessary methods utilized for such preparation and processing.

The inkjettable adhesives utilized in connection with binding layer 106 may be based on a two-component adhesive system where a first component is jetted through a first nozzle and a crosslinking or curing agent (second component) is jetted through a second nozzle onto the first component. In such a case, the viscosity of both components may be maintained at a level to ensure adequate room temperature mixing through diffusion. Suitable first and second component pairs include epoxy oligomers & resins and amine oligomers; epoxy oligomers & resins and acid catalysts; epoxy oligomers and basic catalysts; and oligomers with isocyanate functional groups and alcohols, catalysts, or moisture.

In addition, in a method utilizing the two component adhesive, one component of the two components may be coated/printed/fabricated onto the desired surface/media using additional non-jettable technique, including gravure printing, screen printing, casting, spin coating, die-coating etc. Further, in a method that utilizes the two component adhesive, one of the two components may be situated in ink layer 104 to provide the same effect.

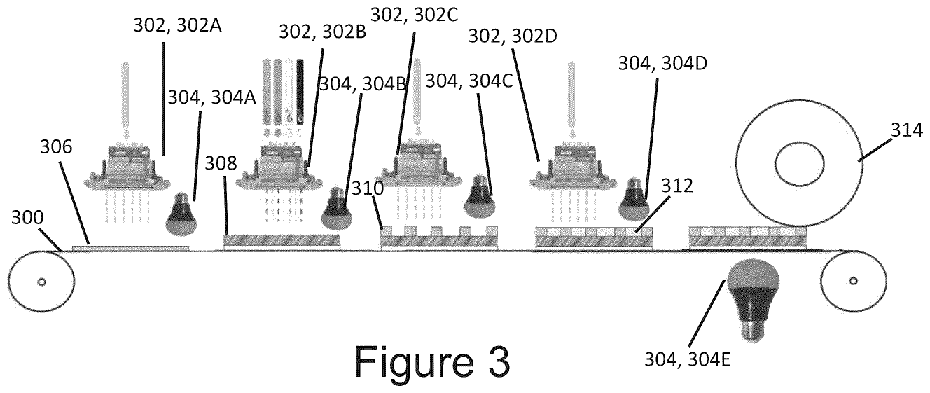

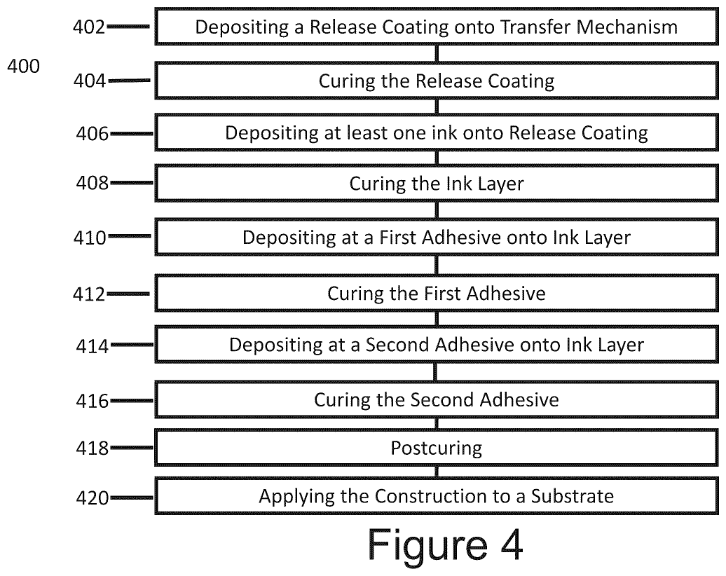

Specifically, in the embodiment of the current disclosure, two specific adhesive systems are used, a first PSA, and a second structural adhesive. Each adhesive is UV-curable or actinic radiation curable. This method is described in FIGS. 3-8. Specifically, FIG. 3 shows a transfer mechanism 300 overlaid with a plurality of depositors 302 and optionally curing devices 304, while FIG. 4 diagrammatically sets out the process 400. Specifically, a first depositor 302A is operative to deposit a release coating 306 onto the transfer mechanism 300 (Step 402). Depending on the content of the release coating 306, it can be UV cured, by first curing device 304A, (Optional Step 404) or may not need to be. The curing devices 304 can be any known mechanism. For example, in the case of UV curing, the devices 304 could be any device known in the art capable of presenting and exposing the release coating to UV light (100-400 nm). Otherwise, the release coating 306 could similar be cured via heat (using other similarly known devices) or additives, without the use of a device entirely. Then, the transfer mechanism 300 moves onto a second depositor 302B where at least one ink layer 308 can be deposited onto the release coating 306 (Step 406) and potentially cured by a second curing device 304B (Optional Step 408).

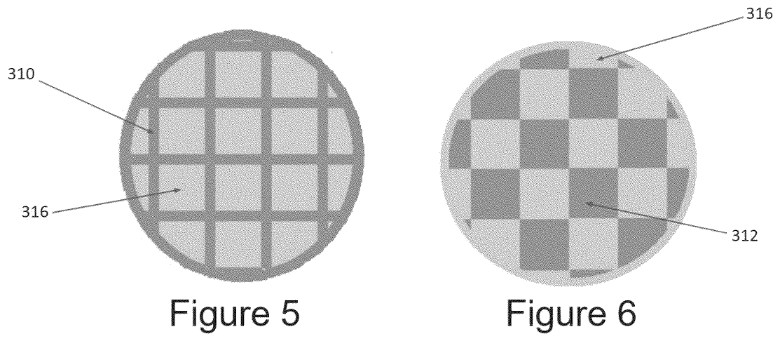

Next, the transfer mechanism 300 moves onto a third depositor 302C where a first adhesive 310 can be deposited onto the ink layer (Step 410) and potentially cured by a third curing device 304C (Optional Step 412). The first adhesive 310 is deposited in a regular and repeating pattern onto the ink layer. In an exemplary embodiment, this pattern is a grid like shape as seen in FIG. 5. This grid shape results in an internal void 316 defined by the absence of adhesive in a depth, width and length of the first adhesive 310. While this regular and repeating pattern is the result of the method and execution of the deposition in the exemplary embodiment, it is possible for other patterns to be used in the desired implementation. These other patterns may include, but are not limited to any hollow polyhedral shapes with similarly situated voids that have a polygon as its approximated shape when viewed in cross section along the width and length, thus making the underlying polyhedron a prismatic. For example, in the exemplary embodiment as is shown in FIG. 5, the approximated shape when viewed in cross section along the width and length is a hollow square.

After this, the transfer mechanism moves onto the fourth depositor 304D where a second adhesive 312 can be deposited onto the ink layer (Step 414) and potentially cured by a fourth curing device 304D (Optional Step 416). The second adhesive 312 is deposited in a regular and repeating pattern onto the ink layer. In an exemplary embodiment, this pattern is a checker board like shape as seen in FIG. 6. This checker board shape results in filling at least a portion of the internal voids 316 defined by the absence of first adhesive 310 by covering in width and length while equal to or less than of the depth of the first adhesive 310. While this regular and repeating pattern is the result of the method and execution of the deposition in the exemplary embodiment, it is possible for other patterns to be used in the desired implementation. The pattern of the second adhesive 312 is meant to mirror that, or rather fill the resultant void 316 of the pattern of the first adhesive 310. These other patterns may include, but are not limited to any solid polyhedral shapes with similarly situated voids that have a polygon as its approximated shape when viewed in cross section along the width and length, thus making the underlying polyhedron a prismatic. For example, in the exemplary embodiment as is shown in FIG. 6, the approximated shape when viewed in cross section along the width and length is a solid square.

The first adhesive 310 deposition and subsequent cure results as a container for the second adhesive 312 to restrain the potential spread of the second adhesive. Therefore, potential second adhesives 312 that would have too low of viscosity to be reasonably workable under normal conditions prior to curing, are now able to remain specifically in one section prior to cure without risk of flowing to undesirable locations. In the exemplary embodiment the first adhesive 310 is a PSA while the second adhesive 312 is a structural adhesive. The second adhesive 312 has a viscosity lower than the first adhesive after the first adhesive is cured.

Next, the transfer mechanism moves onto a potential final curing device 304E (Optional Step 418) before being removed from the transfer mechanism 300 and attaching to a substrate 314 (Step 420). Instead of a substrate, depending on the desired implementation the resultant dual cured adhesive and ink containing material may be saved for future use prior to immediate application.

In alternative embodiments, the cure of the second adhesive 312 (Optional Step 416) and could be removed. When this step is removed, there could instead be a UV cure that could occur nearly simultaneously to removal of the transfer mechanism 300. When this occurs, and the cure is a UV cure it must be done through a transparent web liner and color layer with respect to the curing wavelength.

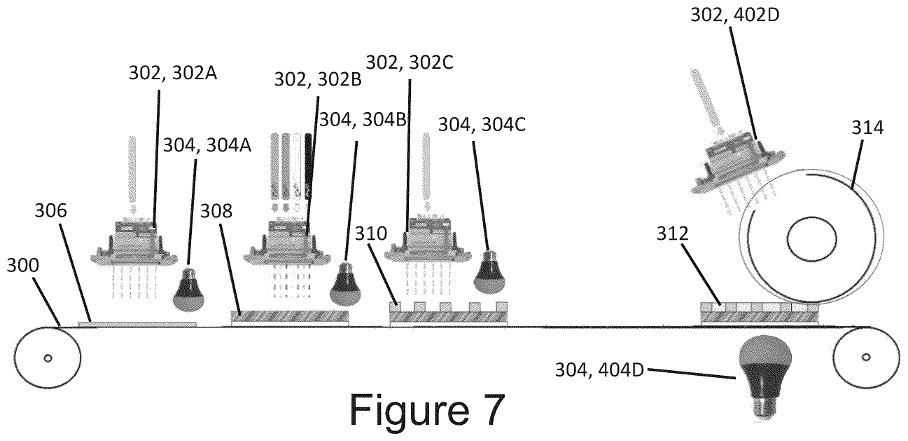

In another alternative embodiment, as shown in FIG. 7, the second adhesive 312 is deposited onto a wrapped film 400 by a fourth depositor 402D. The result is a structural adhesive wet film. This fourth depositor is located sufficiently adjacent to a roll 414. The roll then rotates and is put into contact, allowing the second adhesive 312 to be placed within the voids of the pattern of the first adhesive 310. The resultant now has both adhesives 310, 312 and is exposed to a final curing mechanism 404D, rather than a series of individual cures followed by a final cure in the prior embodiments. The resultant material with both the first adhesive 310 and second adhesive 312 being cured may be applied to the roll and the whole construction may be self wound and resultant dual cured adhesive and ink containing material may be saved for future use prior to immediate application, or depending on the desired implementation the material may be immediately used.

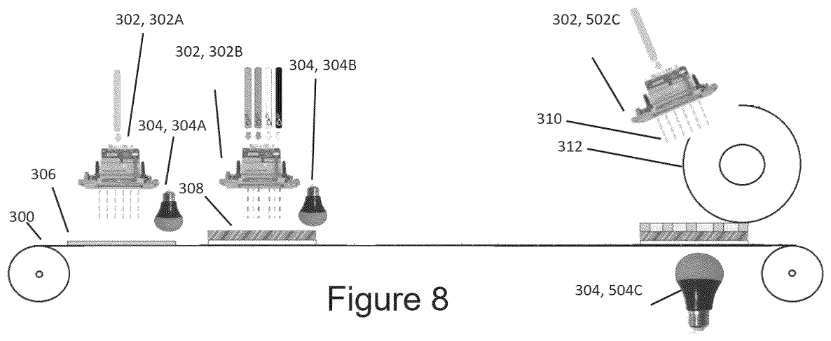

In yet another alternative embodiment, as shown in FIG. 8, the first adhesive 310 is deposited using a depositor 502C while the second adhesive 312 is present on as a modified wrap transfer with the second adhesive 312 as a primer. The resultant wrap is then merged with the release portion and color portion near simultaneously to curing 504C. The resultant material with both the first adhesive 310 and second adhesive 312 being cured may be applied to the roll and the whole construction may be self wound and resultant dual cured adhesive and ink containing material may be saved for future use prior to immediate application, or depending on the desired implementation the material may be immediately used.

All definitions, as defined and used herein, should be understood to control over dictionary definitions, definitions in documents incorporated by reference, and/or ordinary meanings of the defined terms.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

An embodiment is an implementation or example of the present disclosure. Reference in the specification to “an embodiment,” “one embodiment,” “some embodiments,” “one particular embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0. % of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, any method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures.

In the foregoing description, certain terms have been used for brevity, clarity, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

1. A method comprising:
depositing a first adhesive in a pattern, wherein the pattern has a length, a width, and a depth and locations with no depth of a first adhesive thereby creating a resultant void;
curing the first adhesive;
depositing a second adhesive within the resultant void of the pattern; and
curing the second adhesive.

2. The method of claim 1, wherein the first adhesive is a pressure sensitive adhesive.

3. The method of claim 1, wherein the second adhesive is a structural adhesive.

4. The method of claim 1, wherein the height is a first height of the first adhesive and the second adhesive has a second height and wherein the first height is greater than or equal to the second height.

5. The method of claim 1, wherein the curing of the first adhesive occurs through actinic radiation.

6. The method of claim 1, wherein the curing of the second adhesive occurs through actinic radiation.

7. The method of claim 1, wherein a viscosity of the first adhesive is greater than a viscosity of the second adhesive.

8. The method of claim 1, wherein the depositing the first adhesive occurs through an ink-jet printer.

9. The method of claim 1, wherein the depositing the second adhesive occurs through an ink-jet printer.

10. The method of claim 1, wherein the resultant void is shaped like a polygon in cross section along the width and length.

11. An article of manufacture comprising:
a first cured adhesive applied in a pattern to a substrate, wherein the pattern includes a plurality of voids; and
a second cured adhesive applied within the plurality of voids of the first adhesive.

12. The composition of claim 11, wherein the first cured adhesive was a UV-curable adhesive prior to being cured.

13. The composition of claim 12, wherein the first cured adhesive is a pressure sensitive adhesive.

14. The composition of claim 11, wherein the second cured adhesive was a UV-curable adhesive prior to being cured.

15. The composition of claim 14, wherein the second cured adhesive is a structural adhesive.

16. The composition of claim 11, wherein the first cured adhesive has a first height and the second cured adhesive has a second height and wherein the first height is greater than or equal to the second height.

17. The composition of claim 11, wherein the first cured adhesive prior to curing has a viscosity greater than the second cured adhesive prior to curing.

18. The composition of claim 11, wherein the pattern of the first cured adhesive is grid shaped.

19. The composition of claim 18, wherein the pattern of the second cured adhesive is polygon shaped when viewed in cross section along the width and length.

20. The composition of claim 19, wherein the pattern of the second cured adhesive is rectangle shaped when viewed in cross section along the width and length.
